(19) United States
(12) Patent Application Publication
(10) Pub. No.: US 2017/0339927 A1
(43) Pub. Date: Nov. 30, 2017

(54) BIRD FEEDER WITH A ONE-PIECE FEED CONTAINER

(71) Applicant: PAUL L. COTE, Knowlton (CA)

(72) Inventor: PAUL L. COTE, Knowlton (CA)

(21) Appl. No.: 15/177,490

(22) Filed: Jun. 9, 2016

Related U.S. Application Data
(63) Continuation-in-part of application No. 15/164,181, filed on May 25, 2016.

(51) Int. Cl. A01K 39/01; A01K 39/012

(52) U.S. Cl. CPC A01K 39/0113; A01K 39/012

(57) ABSTRACT

A one-piece feed container for use with a bird feeder including a shroud extending around the feed container. The feed container is cylindrical in shape and has an upper end and a lower end. A feed inlet structure is positioned in the upper end of the feed container and is molded therewith so that the feed container is of one-piece construction.

This is a Continuation-In-Part application of application Ser. No. 15/164,181 filed May 25, 2016, entitled BIRD FEEDER.

### BACKGROUND OF THE INVENTION

### Field of the Invention

This invention relates to a bird feeder and more particularly relates to a bird feeder which prevents large birds and other animals, such as squirrels, from obtaining feed therefrom. Even more particularly, this invention relates to a one-piece feed container for a bird feeder.

### Description of the Related Art

Selective bird feeders are well known in the art and are designed to limit the maximum size of a bird or animal which can access the seed in the feeder. The reasons for excluding certain birds may be many. Thus, as disclosed in U.S. Pat. No. 3,241,525, there is provided a selective bird feeder which is specific to cardinals. As taught by this patent, a favorite seed of cardinals is a sunflower seed; this seed is also popular with both smaller and larger birds.

Some larger birds will also access the seed within a bird feeder and many such birds, such as crows, grackles, blue jays and the like are considered by some people to be undesirable.

A further problem associated with bird feeders is marauders which gain access to the seeds. In particular, squirrels are well known for their ability to reach the seed in a bird feeder and to devour the same. Many approaches have been tried to discourage or prevent squirrels from reaching the bird feeder, including various types of covers and baffles on poles. These seldom work as squirrels have shown great ingenuity in overcoming such devices.

There are also many proposals in the art for squirrel-proof bird feeders which utilize a shroud to cover openings in the side wall of a seed container. The shroud is biased to a first upper position, usually by a spring member, such that when weight is placed on the shroud, it moves downwardly to cover the feed openings. Thus, reference may be had to U.S. Pat. Nos. 5,445,109 and 6,945,192 which disclose such arrangements.

While such shroud type squirrel proof bird feeders are useful, they are relatively costly to manufacture and assemble due to different requirements such as maintaining the openings in the shroud and openings in the side wall of the seed container in alignment. One must also take into account inclement weather which can affect the functioning of the bird feeder.

A distinct improvement in the prior art is shown in Applicant's U.S. Pat. No. 7,739,982 B2. A further improvement in the art is disclosed in the co-pending application wherein three different types of springs are disclosed for yieldably maintaining the shroud of the bird feeder to an upper position with respect to the feed container. When weight is placed on the shroud, it moves downwardly with respect to the feed container to cover the feed openings of the feed tray.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A one-piece feed container is disclosed for use with a bird feeder. The feed container of this invention is hollow and has a cylindrical configuration. The feed container has an upper end and an open lower end. A feed tray is mounted to the feed container at the lower end thereof which is configured to receive feed from the feed container. The upper end of the feed container has a feed inlet structure positioned in the upper end of the feed container. The feed inlet structure is integrally molded with the feed container so that the feed container is of one-piece construction. The feed inlet structure has a plurality of feed openings formed therein which are configured to permit feed to pass downwardly therethrough into the feed container. A vertically disposed hanger rod has its lower end secured to the feed inlet structure and extends upwardly therefrom.

The bird feeder also includes a vertically disposed cylindrical mesh shroud having upper and lower ends. The shroud has a plurality of perches secured thereto at its lower end. The shroud encloses the feed container and the feed tray. The shroud has a ring-shaped wall member or other structure secured thereto which extends around the shroud above the lower end thereof. The shroud also includes a generally cone-shaped cover which is fixedly secured to the upper end of the shroud. The cover includes an outer lower end which has a diameter greater than the diameter of the shroud. The cover also has a central opening formed therein.

The hanger rod extends upwardly through the central opening in the cover whereby the upper end of the hanger rod is positioned above the cover. The upper end of the hanger rod is configured to be operatively secured to an overhead support.

The shroud is vertically movable between an upper position and a lower position with respect to the feed container. The bird feeder also includes a coil spring having upper and lower ends with the coil spring being positioned between the feed inlet structure and the underside of the cover. The lower end of the coil spring is in operative engagement with the upper end of the feed inlet structure and the upper end of the coil spring is in operative engagement with the lower side of the cover. The coil spring yieldably maintains the shroud in its upper position with respect to the feed container. The shroud is movable from its upper position to its lower position upon a squirrel climbing onto the shroud or perches thereon whereby the weight of the squirrel overcomes the yieldable resistance of the spring to permit the shroud to move to its lower position. The ring-shaped wall member on the shroud is positioned outwardly of the feed tray, when the shroud is in its lower position, to deny access to the feed tray.

Although a coil spring is shown, other types of springs could be utilized such as those shown in the co-pending application.

It is therefore a principal object of the invention to provide an improved squirrel resistant bird feeder wherein the feed container thereof is of one-piece construction.

A further object of the invention is to provide a bird feeder which is economical of manufacture, durable in use and refined in appearance.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a bird feeder which includes the one-piece feed container of this invention with the shroud thereof being in its upper position with respect to the feed container thereof so that birds have access to the feed in the feed tray at the lower end of the feed container of the bird feeder;

FIG. 2 is a perspective view of the bird feeder of FIG. 1 wherein the shroud thereof has been lowered to shield the feed tray thereof so that large birds or squirrels are denied access to the feed in the feed tray;

FIG. 3 is a partial upper perspective view of the bird feeder of FIG. 1 with portions thereof being cut-away to more fully illustrate one-piece feed container and with the shroud thereof being in its upper position with respect to the feed container;

FIG. 4 is a partial upper perspective view of the bird feeder of FIG. 1 with portions thereof being cut-away to more fully illustrate the one-piece feed container and with the shroud thereof being in its lower positon with respect to the feed container;

FIG. 5 is a partial perspective view of the bird feeder of FIG. 1 with portions thereof being cut-away to more fully illustrate the one-piece feed container and with the shroud thereof being in its upper position with respect to the feed container;

FIG. 6 is a partial perspective view of the bird feeder of FIG. 1 with portions thereof being cut-away to more fully illustrate the one-piece feed container and with the shroud thereof being in its lower position with respect to feed container;

FIG. 7 is a partial sectional view which illustrates a feed tray secured to the lower end of the one-piece feed container and with the shroud being in its upper position; and

FIG. 8 is a partial sectional view similar to FIG. 7 except that the shroud has been moved to its lower position thereby blocking entrance to the feed tray.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

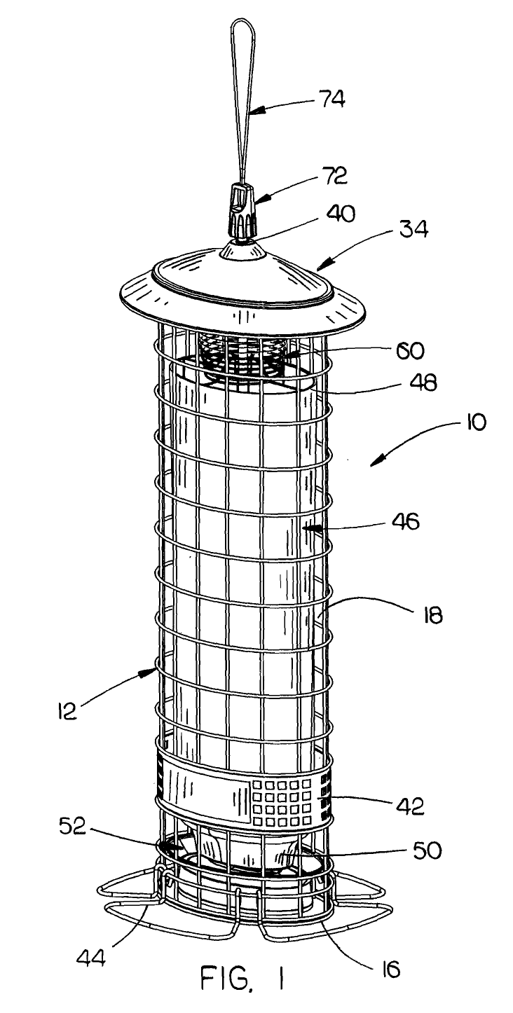

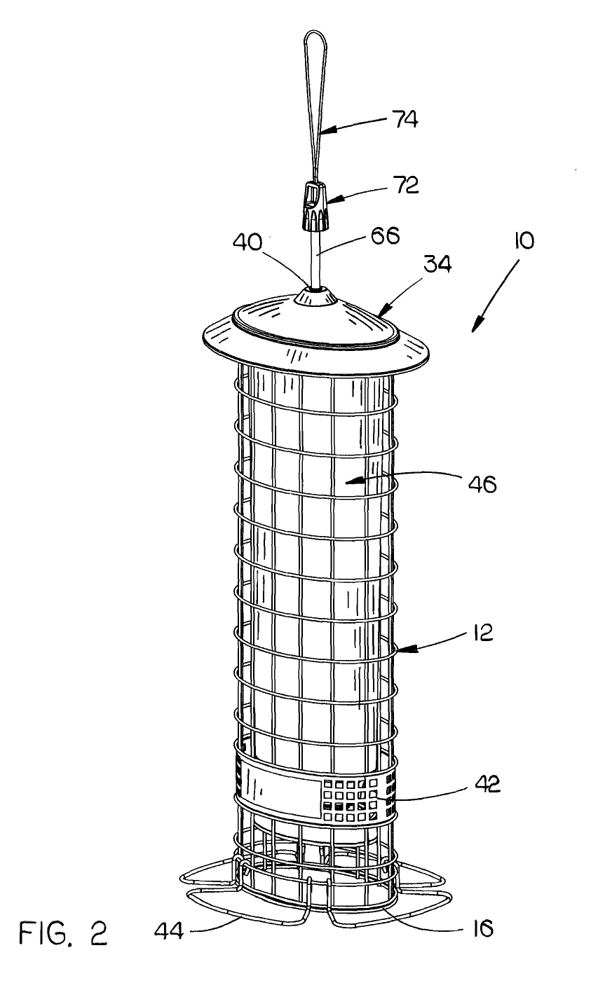

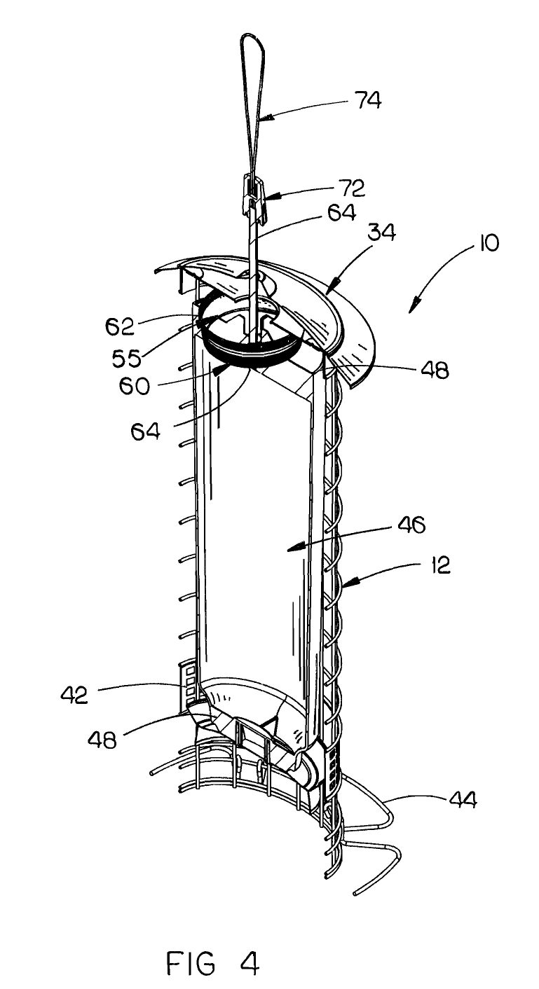

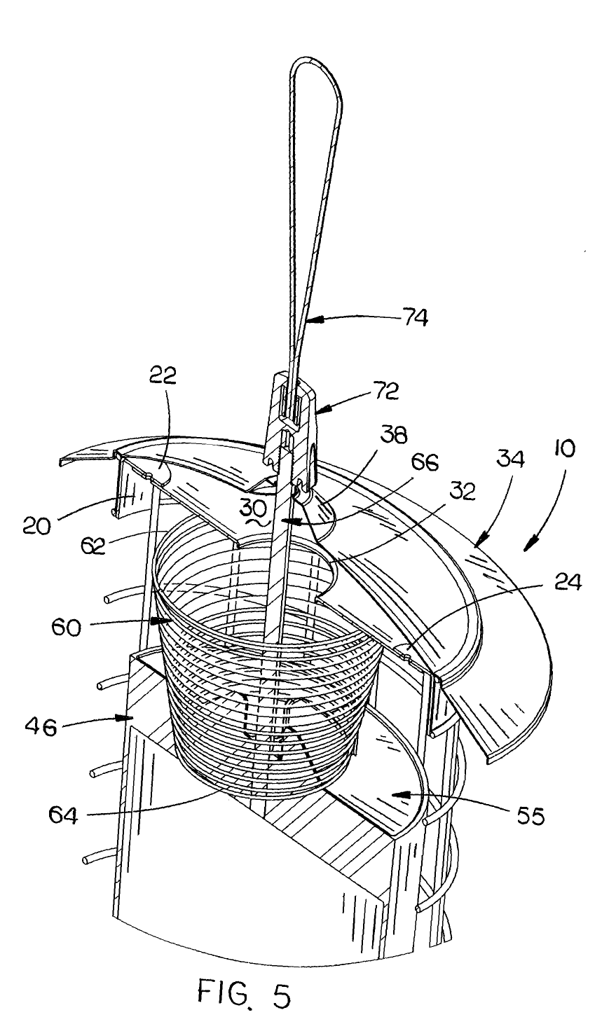

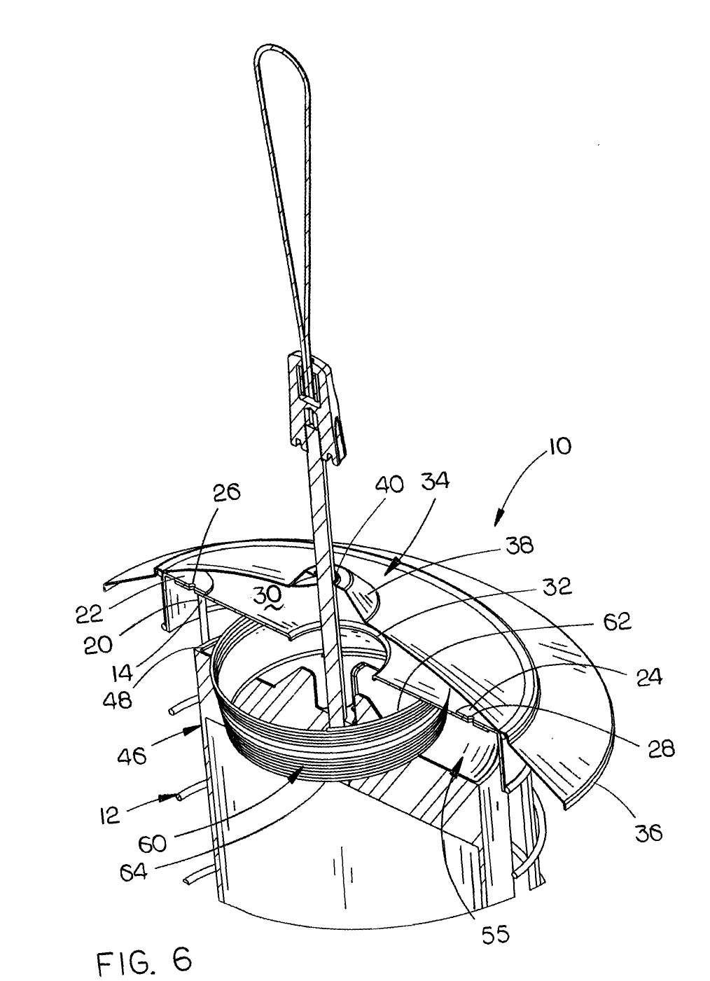

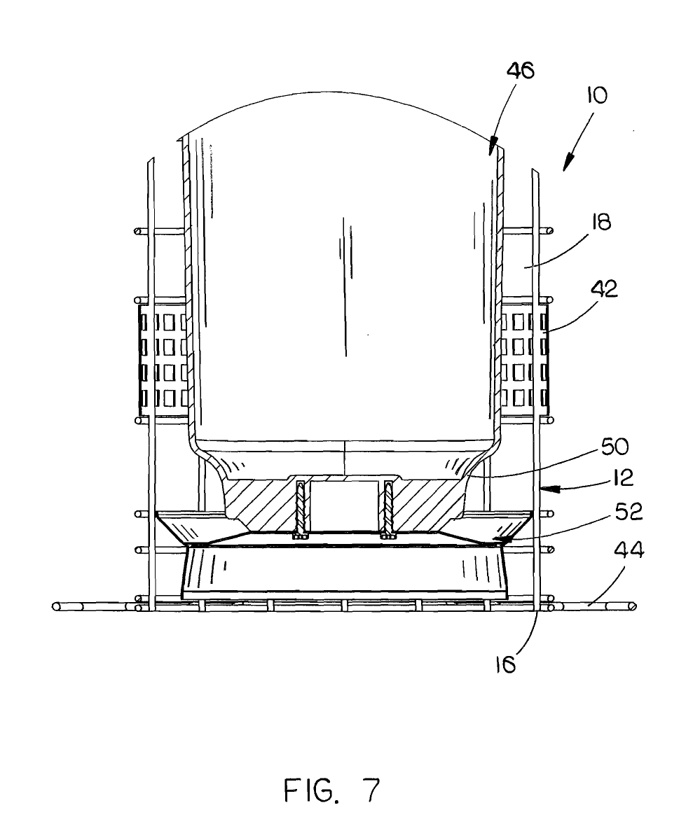

The numeral 10 refers to a squirrel-proof feeder which is illustrated in FIGS. 1-8. Bird feeder 10 includes a vertically disposed shroud 12 having an upper end 14 and a lower end 16. Shroud 12 is comprised of a mesh material having a plurality of openings 18 formed therein. A ring-shaped wall member 20 embraces the upper end of shroud 12 and is secured thereto by welding or any other convenient means and extends therearound as seen in the drawings. The upper end of wall member 20 has a pair of tabs 22 and 24 which extend horizontally inwardly from wall member 20 and which have screw openings 26 and 28 formed therein respectively. A horizontally disposed plate 30 is secured to the undersides of tabs 22 and 24 and extends therebetween. Screws secure the ends of plate 30 to the tabs 22 and 24. Plate 30 has a central opening 32 formed therein. The plate 30 may be omitted in some cases.

The numeral 34 refers to a cover which is secured to the upper end 14 of shroud 12 and/or the upper end of wall member 20 by welding or the like. In the embodiment shown, cover 34 is somewhat cone-shaped and has its lower outer end 36 positioned outwardly of wall member 20 and the upper end of shroud 12 and below the upper end of wall member 20 so as to shield the upper end of the shroud 12. Cover 34 has a frusto-conical shaped member 38 at its upper end with the member 38 having an opening 40 formed therein. Although it is preferred that cover 34 is generally cone-shaped, cover 34 may be flat.

Shroud 12 has a ring-shaped wall member 42 secured thereto by welding or any other convenient means. As seen, wall member 42 ernbraces shroud 12 above the lower end 16 of shroud 12. Wall member 42 could be replaced by a plurality of closely spaced wires or other structure extending around shroud 12. The lower end of shroud 12 has a plurality of radially spaced-apart perches 44 pivotally secured thereto. The perches 44 may not be pivotally secured to the lower end of shroud 12 but could be non-pivotal.

The numeral 46 refers to the one-piece feed container of this invention. Feed container is preferably of plastic construction and is transparent and has an upper end 48 and an inwardly tapered and open lower end 50. As seen, feed container 46 is positioned within shroud 12. A ring-shaped feed tray 52 is secured to the lower end 50 of feed container 46 by any convenient means. Feed tray 52 is configured to receive bird feed from the open lower end 50 of container 46 in conventional fashion. The outer end of feed tray 52 is positioned inwardly of the inside of shroud 12. As will be explained hereinafter, shroud 12 is vertically movable with respect to container 46 between upper and lower positions.

Feed container 46 includes a feed inlet structure 55 which is positioned within the upper end of feed container 46 and which is molded therewith. Feed inlet structure 55 has a plurality of feed inlet openings 56 formed therein to permit feed to pass downwardly therethrough to permit the feed container 46 to be filled with feed. The numeral 60 refers to a spring having an upper end 62 and a lower end 64. As seen, the lower end 64 of spring 60 engages the upper side of feed inlet structure 55. The upper end 62 of spring 60 operatively engages the underside of plate 30. The spring 60 yieldably urges shroud 12 upwardly to its upper position with respect to container 46 as will be described in more detail hereinafter. If the plate 30 is omitted, the upper end of spring 60 will operatively engage the underside of the cover 34. Spring 60 could be replaced with other springs such as seen in the co-pending application.

The numeral 66 refers to a vertically disposed hanger rod having an upper end 68 and a lower end 70. The lower end 70 of rod 66 is secured to feed inlet structure 55 by any convenient means. Rod 66 extends upwardly from feed inlet structure 55, through spring 60, through opening 32 in plate 30, and through opening 40 in member 38. A hanger support 72 is threadably secured to the upper end 68 of rod 66. A hanger loop 74 or other hanger device is secured to hanger support 72 for supporting the bird feeder 10 from some overhead supporting structure such as a tree, pole, etc. Although it is preferred that member 66 be a rod, member 66 could be a cable or other like member.

When it is desired to first place the bird feeder 10 into operation or to re-fill the feed container 46 with bird feed, the bird feeder 10 is placed upon a horizontal support surface such as the ground. The fitting 72 is then threadably disconnected from the upper end 68 of rod 66.

The shroud 12 and the cover 34, which is attached to shroud 12, are then moved upwardly with respect to feed container 46 and removed therefrom. Bird feed is then poured into the feed container 46 by way of the feed inlet structure 55. The bird feed passes downwardly through the feed openings 56 in feed inlet structure 55 into the interior of feed container 46 until the feed tray 52 and the feed container 46 are filled.

The shroud 12, with attached cover 34, is then lowered onto the feed container 46 with the rod 66 extending upwardly through spring 60, through opening 32 in plate 30 and through opening 40 in member 38. The fitting 72 is then threadably secured to the upper end of rod 66. The bird feeder 10 is then hung from an overhead support such as a tree, pole, etc.

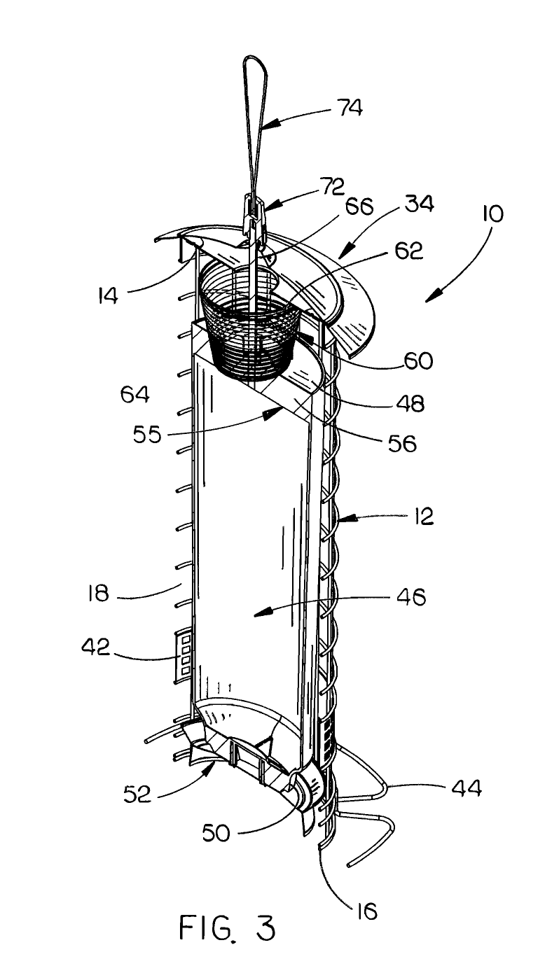

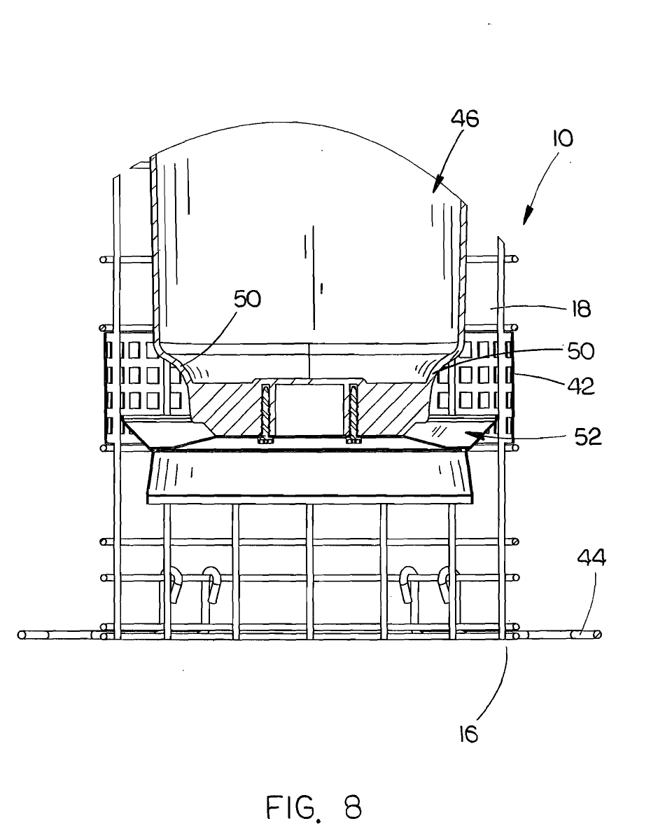

When the seed container 46 is filled with bird feed and the feeder is hung from a support, the spring 60 will yieldably maintain shroud 12 in its upper position with respect to container 46 as seen in FIGS. 1 and 3. When the shroud 12 is in its upper position, the wall member 42 or other structure will be positioned above the openings 18 of shroud 12 which are outwardly of the feed tray 52 so that birds may perch on the perches 44 and have access to the feed in the feed tray 52. If a squirrel moves onto the shroud 12 or onto the perches 44, the weight of the squirrel overcomes the upward force of spring 60 which causes shroud 12 to move downwardly to its lower position with respect to container 46. The downward movement of shroud 12 to its lower position with respect to container 46 causes wall member 42 to be positioned outwardly of feed tray 52 thereby preventing the squirrel from having access to the feed in the feed tray 52 as seen in FIG. 8.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A feed container for use with a bird feeder; comprises:
a vertically disposed and hollow cylindrical member having an upper end and an open lower end;
said cylindrical member having a feed inlet structure extending across said upper end thereof;
said feed inlet structure being integrally molded with said cylindrical member whereby said feed inlet structure and said cylindrical member are of one-piece construction;
said inlet feed structure having a plurality of feed openings formed thereon which are configured to permit feed to pass downwardly therethrough into said cylindrical member;
said lower end of said cylindrical member being configured to have a feed tray secured thereto which is configured to receive feed from said open lower end of said cylindrical member;
a vertically disposed hanger member having upper and lower ends;
said lower end of said hanger member being secured to said feed inlet structure;
said hanger member extending vertically upwardly from said feed inlet structure and said feed container;
a vertically disposed cylindrical mesh shroud having upper and lower ends;
said shroud having a feed tray blocking member secured to and extending around said shroud above said lower end of said shroud;
said shroud enclosing said feed container and said feed tray;
said shroud having a plurality of perches secured thereto at its said lower end;
a cover operatively secured to said upper end of said shroud;
said cover including an outer end which has a diameter greater than the diameter of said shroud;
said cover having a central opening formed therein;
said hanger member extending upwardly through said central opening in said cover whereby said upper end of said hanger member is positioned above said cover;
said upper end of said hanger member being configured to be operatively secured to an overhead support;
said shroud being vertically movable between an upper position and a lower position with respect to said feed container;
a spring positioned between said feed inlet structure and said cover;
said spring being in operative engagement with said feed inlet structure to yieldably maintain said shroud in its said upper position;
said shroud being movable from its said upper position to its said lower position upon a squirrel climbing onto said shroud or perches whereby the weight of the squirrel overcomes the yieldable resistance of said spring; and
said feed tray blocking member being positioned outwardly of said feed tray, when said shroud is in said lower position, to deny access to said feed tray.

2. A bird feeder, comprising:
a vertically disposed and hollow cylindrical member having an upper end and an open lower end;
said cylindrical member having a feed inlet structure extending across said upper end thereof;
said feed inlet structure being integrally molded with said cylindrical member whereby said feed inlet structure and said cylindrical member are of one-piece construction;
said inlet feed structure having a plurality of feed openings formed thereon which are configured to permit feed to pass downwardly therethrough into said cylindrical member;
said lower end of said cylindrical member being configured to have a feed tray secured thereto which is configured to receive feed from said open lower end of said cylindrical member;
a vertically disposed hanger member having upper and lower ends;
said lower end of said hanger member being secured to said feed inlet structure;
said hanger member extending vertically upwardly from said feed inlet structure and said feed container;
a vertically disposed cylindrical mesh shroud having upper and lower ends;
said shroud having a feed tray blocking member secured to and extending around said shroud above said lower end of said shroud;
said shroud enclosing said feed container and said feed tray;
said shroud having a plurality of perches secured thereto at its said lower end;
a cover fixedly secured to said upper end of said shroud;
said cover including an outer end which has a diameter greater than the diameter of said shroud;
said cover having a central opening formed therein;
said hanger member extending upwardly through said central opening in said cover whereby said upper end of said hanger member is positioned above said cover;
said upper end of said hanger member being configured to be operatively secured to an overhead support;
said shroud being vertically movable between an upper position and a lower position with respect to said feed container;
a spring positioned between said feed inlet structure and said cover;
said spring being in engagement with said feed inlet structure to yieldably maintain said shroud in said upper position;
said shroud being movable from its said upper position to its said lower position upon a squirrel climbing onto said shroud or perches whereby the weight of the squirrel overcomes the yieldable resistance of said spring; and
said feed tray blocking member being positioned outwardly of said feed tray, when said shroud is in said lower position, to deny access to said feed tray.

3. A bird feeder comprising:
a vertically disposed and hollow cylindrical member having an upper end and an open lower end;
said cylindrical member having a feed inlet structure extending across said upper end thereof;
said feed inlet structure being integrally molded with said cylindrical member whereby said feed inlet structure and said cylindrical member are of one-piece construction;
said inlet feed structure having a plurality of feed openings formed thereon which are configured to permit feed to pass downwardly therethrough into said cylindrical member;
said lower end of said cylindrical member being configured to have a feed tray secured thereto which is configured to receive feed from said open lower end of said cylindrical member;
a vertically disposed cylindrical mesh shroud having upper and lower ends;
said shroud enclosing said feed container and said feed tray;
said shroud having a plurality of perches secured thereto at its said lower end;
said shroud being vertically movable between an upper position and a lower position with respect to said feed container;
a spring positioned between said feed inlet structure and said cover;
said spring being in engagement with said feed inlet structure to yieldably maintain said shroud in said upper position; and
said shroud being movable from its said upper position to its said lower position upon a squirrel climbing onto said shroud or perches whereby the weight of the squirrel overcomes the yieldable resistance of said spring.
